(19) United States
(12) Patent Application Publication
(10) Pub. No.: US 2010/0332571 A1
(43) Pub. Date: Dec. 30, 2010

(54) DEVICE AUGMENTED FOOD IDENTIFICATION

(76) Inventors: Jennifer Healey, San Jose, CA (US); Rahul Shah, San Francisco, CA (US); Yi Wu, San Jose, CA (US)

Correspondence Address: INTEL/BSTZ;BLAKELY SOKOLOFF TAYLOR & ZAFMAN LLP, 1279 OAKMEAD PARKWAY, SUNNYVALE, CA, 94085-4040, US

(21) Appl. No.: 12/495,561

(22) Filed: Jun. 30, 2009

(51) Int. Cl. G06F 17/30; G06F 3/048

(52) U.S. Cl. 707/912; 715/810; 707/759; 707/769; 707/955; 707/812

(57) ABSTRACT

Methods, apparatuses and systems capture data related to a food item via one or more sensors and narrow the possible identities of the food item by determining the time when the data capture occurred and the location of the food item. A list of nodes based at least in part on the narrowed possible identities is generated to identify the food item and sorted based at least in part on the probability of one or more nodes corresponding to the food item.

### FIELD

Embodiments of the invention generally pertain to device augmented item identification and more specifically to food identification using sensor captured data.

### BACKGROUND

As cell phones and mobile internet devices become more capable in the areas of data processing, communication and storage, people seek to use said phones and devices in new and innovative ways to manage their daily lives.

An important category of information that people may desire to access and track is their daily nutritional intake. People may use this information to manage their own general health, or address specific health issues such as food allergies, obesity, diabetes, etc.

Current methods for managing daily nutritional intake involve manual food diary keeping, a manual food diary keeping augmented with a printed dietary program (e.g. Deal-A-Meal), blogging individual meals using a digital camera (e.g., MyFoodPhone), and tracking food items by label (e.g., barcode scanning and storing bar code data). However, these previous methods of managing daily nutritional intake require an extensive amount of work from the user, require third party (e.g., a nutritionist) analysis, and cannot track food items that do not contain a barcode or other identifying mark (for example, food served at a restaurant does not have a bar code).

### BRIEF DESCRIPTION OF THE DRAWINGS

The following description includes discussion of figures having illustrations given by way of example of implementations of embodiments of the invention. The drawings should be understood by way of example, and not by way of limitation. As used herein, references to one or more “embodiments” are to be understood as describing a particular feature, structure, or characteristic included in at least one implementation of the invention. Thus, phrases such as “in one embodiment” or “in an alternate embodiment” appearing herein describe various embodiments and implementations of the invention, and do not necessarily all refer to the same embodiment. However, they are also not necessarily mutually exclusive.

FIG. 1 is a block diagram of a system or apparatus to execute a process for computer augmented food journaling.

FIG. 2 is a flow diagram of an embodiment of a process for device augmented food journaling.

FIG. 3 is a block diagram of a system or apparatus to execute food item identification logic.

FIG. 4 is a flow diagram of an embodiment of a process for food journaling using captured audio data and user dietary history.

FIGS. 5A-5C are block diagrams of a system to execute mobile device augmented food journaling using captured image data and user dietary history.

Descriptions of certain details and implementations follow, including a description of the figures, which may depict some or all of the embodiments described below, as well as discussing other potential embodiments or implementations of the inventive concepts presented herein. An overview of embodiments of the invention is provided below, followed by a more detailed description with reference to the drawings.

### DETAILED DESCRIPTION

Embodiments of the present invention relate to device augmented food journaling. Embodiments of the present invention may be represented by a process using captured sensor data with time and location data to identify a food item.

In one embodiment, a device or system may include a sensor to capture data related to a food item. The term “food item” may refer to any consumable food or beverage item. In the embodiments described below, said sensor may comprise an optical lens or sensor to capture an image of a food item (or a plurality of food items), or an audio recording device to capture an audio description of the food item (or a plurality of food items).

The device or system may further include logic to determine the time and location of a data capture. The term “logic” used herein may be used to describe software modules, hardware modules, special-purpose hardware (e.g., application specific hardware, application specific integrated circuits (ASICs), digital signal processors (DSPs)), embedded controllers, hardwired circuitry, etc. The location of the device when the data capture occurred may be used to determine a specific vendor of the food item, and the time of the data capture may be used to identify a subset of possible food items provided by the specific vendor.

In one embodiment, a device contains all the necessary logic and processing modules to execute the food item recognition processes disclosed herein. In another embodiment, a mobile platform may communicate with a backend server and/or database to produce the food item recognition results.

Prior art food journaling processes use devices sparingly, and require significant user input. For example, photo-food journaling involves a user taking images of meals consumed throughout a specific period, but offers no efficient way to identify a meal—a user must identify the meal manually by uploading text describing and identifying the meal. Furthermore, to obtain nutritional information of a food item, the user must interact with a nutritionist (e.g., MyFoodPhone) or manually obtain a food vendor's published nutritional information, and lookup the item to be consumed by the user.

As personal devices, such as cell phones and mobile internet devices, become more common, it becomes possible to provide users of said devices with immediate processing-intensive analysis to assist in managing their daily nutritional intake. Device augmented food journaling, as described herein, provides a user with an immediate analysis of food items about to be consumed with little user interaction. This provides great assistance for users following specific diet programs for weight loss, diabetes treatments, food allergies, etc.

Embodiments subsequently disclosed advance the state of the art by assisting in identifying food items prior to consumption and reducing the burden of record keeping. To identify a specific food item, embodiments may use a collection of sensors and logic collaboratively to produce a list of possible items that match said specific food item, and then use a recognition algorithm to either identify the food items exactly or return a short, ranked list to the user from which they may easily select the correct choice.

To limit the search space of all possible items that may match the specific food item, embodiments may use available context information. Said context information may include the time of day when the food item was ordered/received, the identity of the vendor of the food item, published information describing the types of foods available from said vendor, and previous food item identification. The published food information for a specific vendor may be obtained via a network interface, as many food vendors publish menus and related nutritional information via internet or database lookup. Taken together this context information may be used to greatly reduce the search space so that food recognition algorithms, such as computer vision and speech recognition algorithms, will produce quick and accurate results.

In one embodiment, a device may determine a sufficient amount of context information to limit the search space via logic further included in said device. For example, the following sources of information may be obtainable by a device: time of day (via a system clock) and location (via a geo-locating device, a Global Positioning System (GPS) device, a local positioning system, cell tower triangulation, WiFi-based positioning system (WPS) or similar locationing technologies and/or some combination of the above).

In one embodiment, possible food items displayed to the user are further prioritized with user history information. If a user history is extensive, the food recognition logic may assume its results are correct and the device may either prompt the user for confirmation, or go directly to a list of sub-options for add-ons such as condiments.

In one embodiment, the generated list of possible matching items is accompanied by a confidence index based either on a high degree of probability determined from any single recognition algorithm or from agreement between algorithms. For example, logic may be executed to run a vision algorithm that compares a captured image to a database of labeled images. Said algorithm may return a vector comprising a ranked list of images most similar to the captured image. If the first 20 matches to any one of the algorithms were “pizza,” food item identification logic may determine, with a high degree of confidence, that the food item is in fact pizza. Alternatively if the top 5 ranked items from a first algorithm (e.g., a shape recognition algorithm) were all “pizza” and the top five ranked items from a second algorithm (e.g., a color-matching algorithm) were also pizza, there would be a higher degree of confidence that said food item is in fact pizza. Similarly if a user's personal history shows that said user has had pizza at this particular location frequently, or an ambient audio small vocabulary word recognition algorithm detected a match to “pizza” (e.g. a audio data capture of a user saying “yes, can I have the pepperoni pizza?”), a results list of entirely pizza food items is likely contain an item matching the ordered food item.

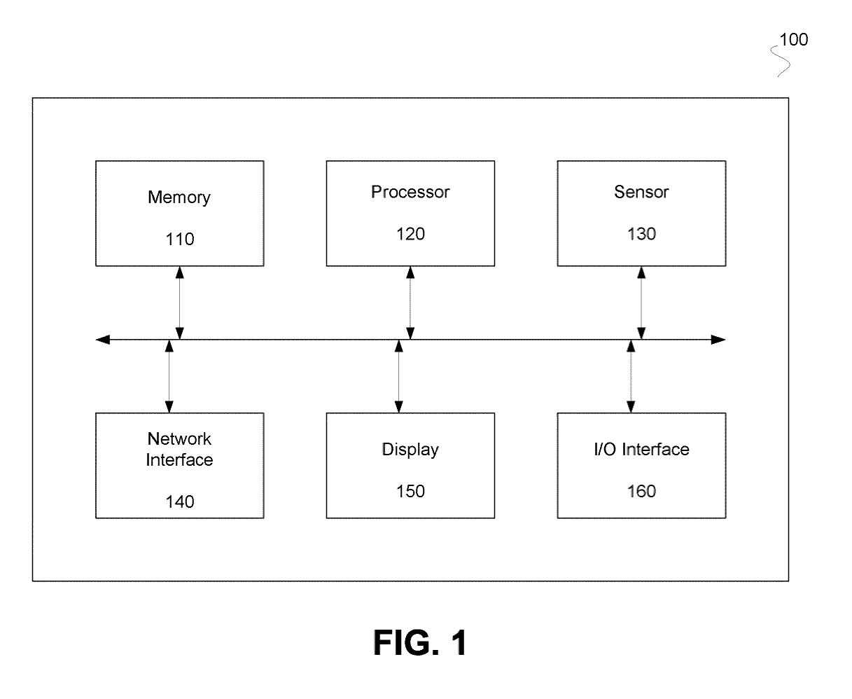

FIG. 1 a block diagram of a system or apparatus to execute a process for device augmented food journaling. The following discussion refers to block 100 as an apparatus; however, block 100 may comprise a system, wherein the sub-blocks contained in block 100 may be contained in any combination of apparatuses.

Apparatus 100 includes a processor 120, which may represent a processor, microcontroller, or central processing unit (CPU). Processor 120 may include one or more processing cores, including parallel processing capability.

Sensor 130 may capture data related to a food item. Sensor 130 may represent an optical lens to capture an image of a food item, a microphone or other sound capturing device to capture audio data identifying a food item, etc.

Data captured by sensor 130 may be stored in memory 110. Memory 110 may further contain a food item identification module to identify the food item based at least in part on data captured by sensor 130. In one embodiment, memory 110 may contain a module representing an image recognition algorithm to match image data captured by sensor 130 to other food images stored in memory. In another embodiment, memory 110 contains a module representing a speech recognition algorithm (e.g., Nuance Speech and Text Solutions, Microsoft Speech Software Development Kit) to match audio data captured by sensor 130 to known descriptions of food items. Known descriptions of food items may be obtained via network interface 140. Sensor 130 may further capture data identify a plurality of food items, and said image and speech recognition algorithms may further determine the quantity of food items in the captured data. Furthermore, device 100 may exchange data with an external device (e.g., a server) via network interface 140 for further processing.

A generated and sorted list of nodes containing possible identifications for the food item may be displayed to a user via display 150. I/O interface 160 may accept user input to select the node that best identifies the food item.

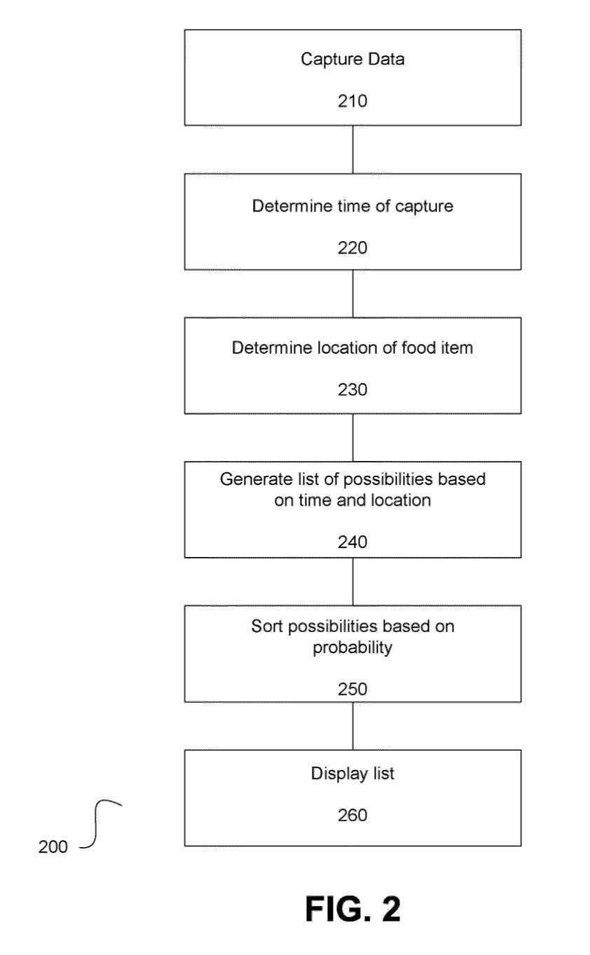

FIG. 2 is a flow diagram of an embodiment of a process for device augmented food journaling. Flow diagrams as illustrated herein provide examples of sequences of various process actions. Although shown in a particular sequence or order, unless otherwise specified, the order of the actions can be modified. Thus, the illustrated implementations should be understood only as examples, and the illustrated processes can be performed in a different order, and some actions may be performed in parallel. Additionally, one or more actions can be omitted in various embodiments of the invention; thus, not all actions are required in every implementation. Other process flows are possible.

Process 200 illustrates that a device may capture data to identify a food item, 210. The device may further determine the time of the data capture, 220. In one embodiment, a time stamp is stored with the captured data. The device may further determine the location of the food item, 230. Location may be determined via a GPS device or other technology to determine geo-positioning coordinates, wherein geo-positioning coordinates may be stored with the captured data.

Time and location data associated with the food item may be used to determine a list of nodes, wherein one or more nodes represents a possible matching food item, 240. For example, GPS data may be used to determine the food item is at “Food Vendor X” and the time stamp of “9:00 a.m.” may further limit the nodes to represent breakfast items only. In one embodiment, a menu of the vendor of the food item is retrieved from the internet via a network interface included on the device. In another embodiment, a menu of the vendor of the food item is retrieved from device-local storage.

Said list may be sorted based at least in part on the probability of one or more nodes matching said food item, 250. Probability may be determined by visual match, audio match, user history, or any combination thereof. The sorted list of nodes may then be displayed to the user. The user may select the matching node from the list, and the matching node may be added to the user's meal history and/or recorded for further data processing (e.g., long term nutritional analysis, meal analysis, etc.). The sorted list is then displayed on the device, 260.

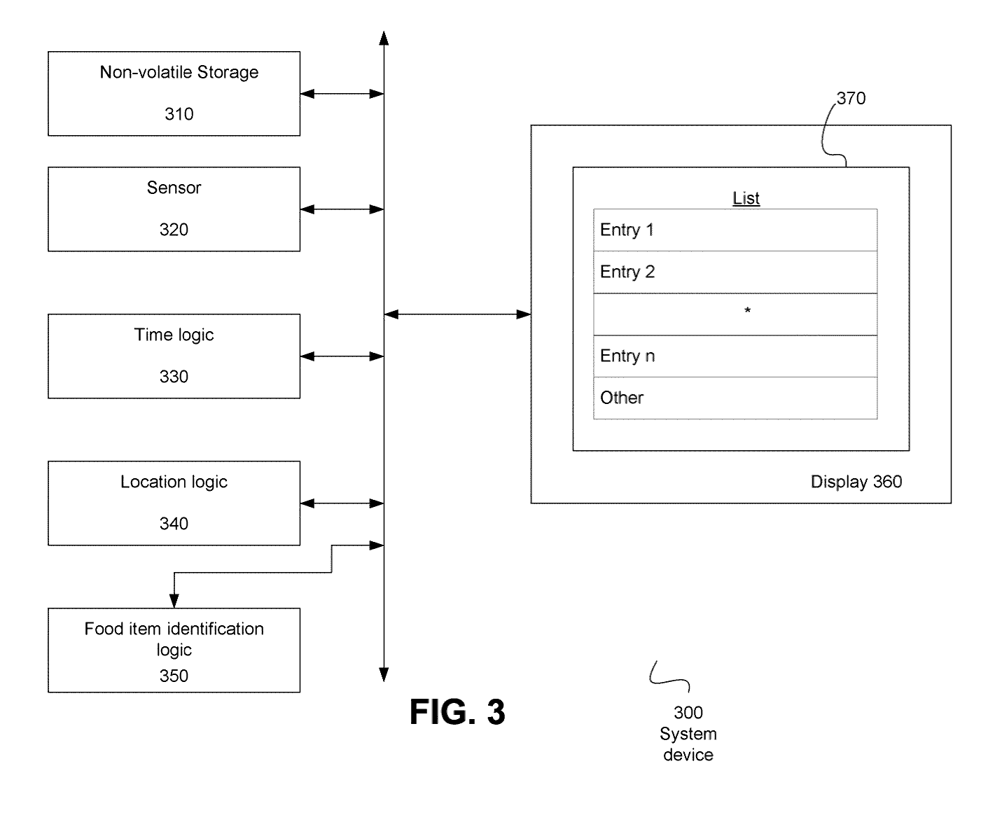

FIG. 3 is a block diagram of a system or apparatus to execute food item identification logic. System or apparatus 300 may include sensor 320, time logic 330, location logic 340, food identification logic 350, and display 360. In one embodiment of the invention, a user may physically enter a food vendor location and apparatus 300 recognizes the time of day via time logic 330 and the identity of the food vendor via location logic 340. In one embodiment, if the user has previously come to the restaurant, a likelihood bias is given to previously ordered foods at this restaurant, otherwise a standard set of biases based at least in part on what the user generally eats at this time of day are employed. The user may further capture a picture of the food item if sensor 320 is an optical lens included in a digital camera, or may speak a description of their food into sensor 320 if it is an audio recording device.

Food item identification logic 350 may execute a vision and/or a speech recognition algorithm to generate list of nodes 370 to identify the food item. The user may simply confirm one of the entries listed, confirm and go on to a list of details to add depth to the description, or select “Other” to manually input an item not contained in list 370. Selection of the item from list 370 may then be saved to non-volatile storage 310 as user historical meal data. Non-volatile storage 310 may further include dietary restrictions of a user, and present information to the user via display 360 recommending (or not recommending) the consumption of the food item.

In one embodiment, system or apparatus 300 may use historical meal data stored in non-volatile storage 310 for nutritional trending or for identification of unlabeled items. For example using context information and food item identification logic 350, system or apparatus 300 may inform the user, via display 360, “in the last month you had ten hamburgers as your lunch” or “every Friday you had ice cream after dinner.” Other user information (e.g., dietary restrictions, food allergies, general food preferences) may be included in non-volatile storage 310. Food item identification logic 350 may also group similar items that the user has yet to identify to encourage labeling. For example, system or apparatus 300 may show the user, via display 360, a series of grouped images that the user has yet to identify and prompt the user to identify one or more images in the group. Identified images may be saved in non-volatile storage 310 for future use.

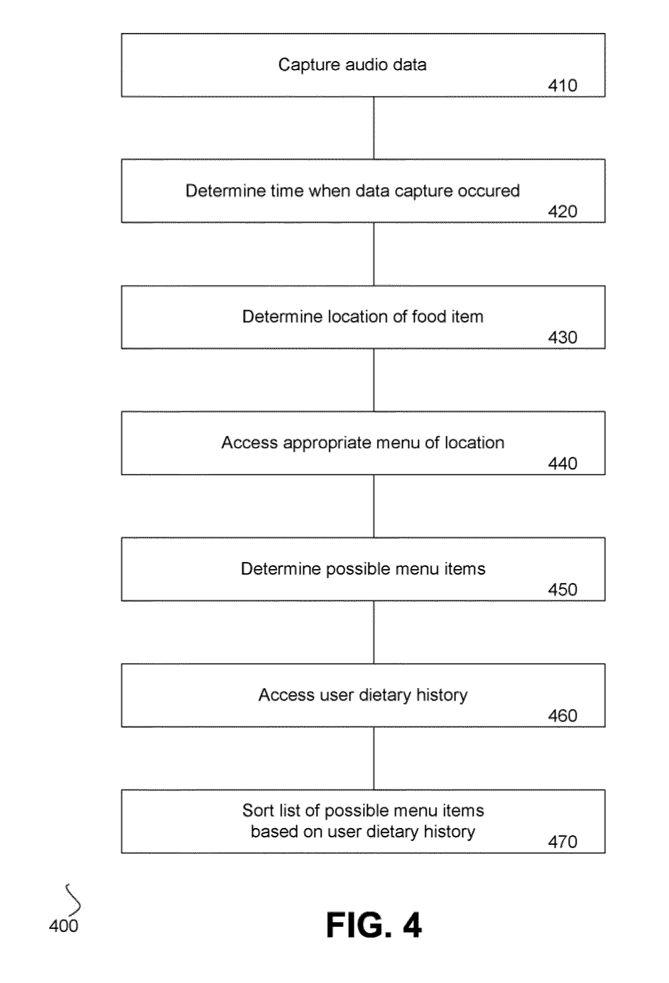

FIG. 4 is a flow diagram of an embodiment of a process for food journaling using captured audio data and user dietary history. Process 400 illustrates that a device may capture audio data to identify a food item, 410. For example, a device may include a microphone and a user of said device may record a vocal description of the item (e.g., recording of the user saying the phrase “burrito”). The time when the data capture occurred is determined, 420. For example, the device may time stamp the recorded vocal description with time “9:00 a.m.” The location of the vendor providing the food item is determined, 430. In one embodiment, the device includes a GPS device, and the location is determined as previously described. In another embodiment, the sensor will record the user saying the identity of the vendor providing the food item. The time-appropriate menu for the location is accessed, 440. For example, based on the time stamp described above, the device will access a menu of breakfast items published by the vendor. A speech recognition algorithm is executed to eliminate unlikely items from the time appropriate menu from the list, 450. Thus, the speech recognition algorithm will identify all items on the published menu that contain the phrase “burrito” and eliminate all other items. The dietary history of the user may be accessed 460. The remaining items are displayed as a list of nodes, wherein the nodes are sorted based at least in part on the recognition algorithm and the dietary history of the user, 470. User history may show that the user has never ordered any food item that contains pork, and thus all burritos not containing pork will be represented as nodes at the top of the sorted list.

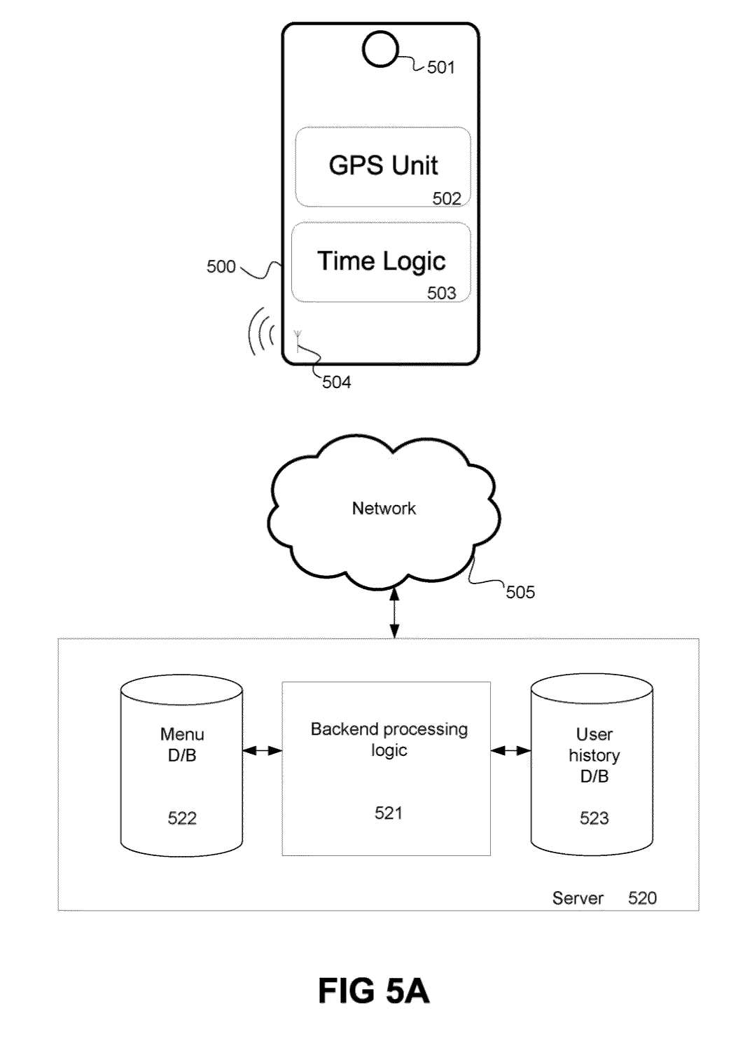

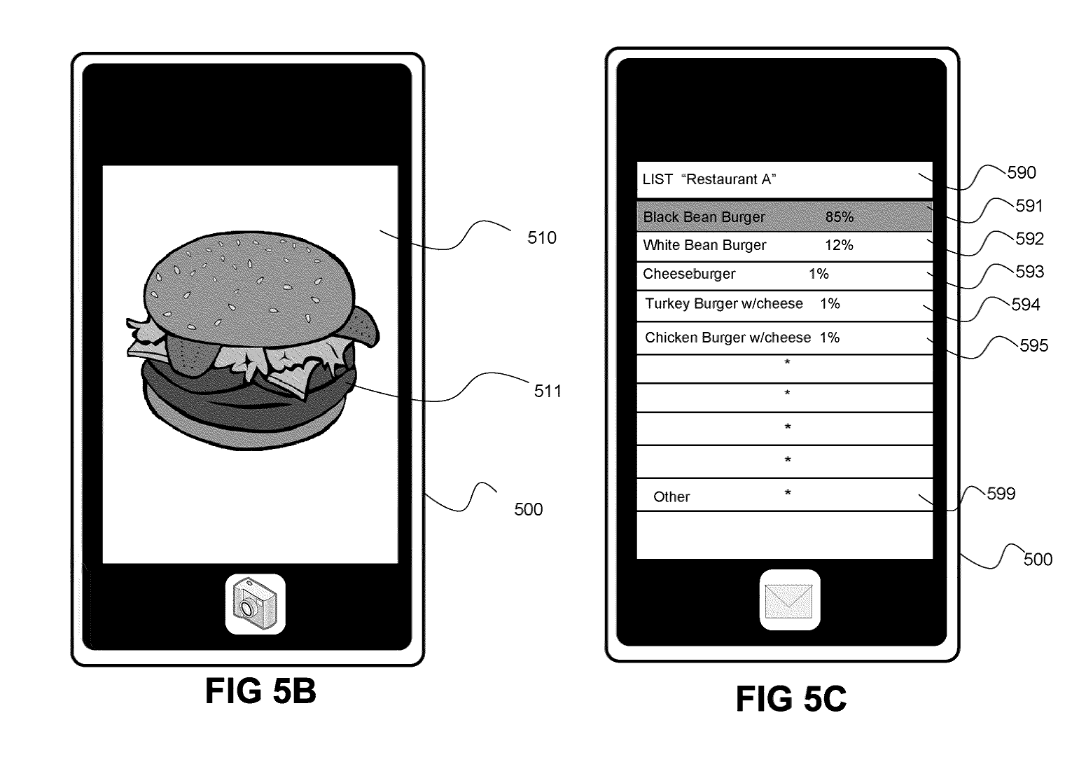

FIGS. 5A-5C illustrate an embodiment of a system to execute mobile device augmented food journaling. Device 500 may include an image capturing device (e.g., a digital camera), represented by optical lens 501, to capture an image 510 of food item 511. GPS unit 502 may capture geo-positioning data of food item 511. Time logic 503 may capture a time stamp of when image 510 was taken.

Device 500 may further include a wireless antenna 504 to interface with network 505. Device 500 may transmit image 511, geo-positional data and time data to server 520 for backend processing.

In one embodiment, server 520 includes backend processing logic 521 to generate a sorted list of probable food items 590. Backend processing 522 logic may identify a specific restaurant where the food item is located (e.g., “Restaurant A”) and access the restaurant's stored menu from menu database 522. Backend processing logic may further reduce the possible food items by removing from consideration items that are not served at the time of the data capture, e.g., eliminating breakfast menu items after a specific time.

As illustrated in FIG. 5B, food item 511 is a sandwich, but it is unclear what specific sandwich is represented in image 510. Thus, backend processing logic 521 may execute image recognition logic to determine food item 511 is one of a subset of items: a cheeseburger, a chicken burger with cheese, and turkey burger with cheese, and black bean burger or a white-bean burger (and not consider “breakfast burgers”). Backend processing logic 521 may further obtain the user's food item identification history from database 523. For example, a user's food item identification history may indicate that said user has never selected an entrée containing meat. Thus, it is probable that food item 511 is one of the bean burgers listed. Other visual aspects of image 510, i.e., color of the patty in image 510 appearing closer to a black bean burger rather than a white bean burger, may further be factored into determining the probability of one or more nodes.

Backend processing may generate list 590 and transmit the list over network 505 to device 500. List 590 may then be displayed on device 500. Entries 591-595 are listed with their determined probability. The user may select any entry displayed, or select “Other” option 599 to input an entry not listed. If “Other” option 599 is selected because the user ordered an item not listed in the menu stored in database 522, image 510 may be stored with a new description at database 522 to better match food item 511 in the future.

Besides what is described herein, various modifications may be made to the disclosed embodiments and implementations of the invention without departing from their scope. Therefore, the illustrations and examples herein should be construed in an illustrative, and not a restrictive sense. The scope of the invention should be measured solely by reference to the claims that follow.

Various components referred to above as processes, servers, or tools described herein may be a means for performing the functions described. Each component described herein includes software or hardware, or a combination of these. The components can be implemented as software modules, hardware modules, special-purpose hardware (e.g., application specific hardware, ASICs, DSPs, etc.), embedded controllers, hardwired circuitry, etc. Software content (e.g., data, instructions, configuration) may be provided via an article of manufacture including a computer storage readable medium, which provides content that represents instructions that can be executed. The content may result in a computer performing various functions/operations described herein. A computer readable storage medium includes any mechanism that provides (i.e., stores and/or transmits) information in a form accessible by a computer (e.g., computing device, electronic system, etc.), such as recordable/non-recordable media (e.g., read only memory (ROM), random access memory (RAM), magnetic disk storage media, optical storage media, flash memory devices, etc.). The content may be directly executable (“object” or “executable” form), source code, or difference code (“delta” or “patch” code). A computer readable storage medium may also include a storage or database from which content can be downloaded. A computer readable medium may also include a device or product having content stored thereon at a time of sale or delivery. Thus, delivering a device with stored content, or offering content for download over a communication medium may be understood as providing an article of manufacture with such content described herein.

1. A method comprising:
capturing, via one or more sensors included in a device, data related to a food item;
determining the geographic location of the device when the data was captured;
generating a list of nodes to identify the food item, wherein one or more nodes of the list represents a food item available at the geographic location, the list based at least in part on the data and the geographic location of the device when the data was captured; and
sorting the list of nodes for a user of the device, wherein the sorting is based at least in part on a probability of one or more nodes corresponding to the food item to be identified.

2. The method of claim 1, further comprising determining the time when the data capture occurred, wherein the list is based at least in part on the time when the data capture occurred.

3. The method of claim 1, wherein one of the sensors included in the device is an optical lens, the captured data comprises image data, and the image data includes an image of the food item.

4. The method of claim 1, wherein one of the sensors included in the device is a microphone, and the captured data comprises an audible description of the food item.

5. The method of claim 1, wherein generating a list of nodes includes:
retrieving user information via a network interface included on the device, wherein the list is sorted based at least in part on the retrieved user information.

6. The method of claim 5, wherein the retrieved user information comprises history of prior food item identification for the user.

7. The method of claim 1, wherein the device further includes a Global Positioning System (GPS) and determining the geographic location of the food item comprises determining the global position of the device when the data was captured.

8. The method of claim 1, further comprising retrieving, via a network interface included in the device, a network accessible menu of food items available at the geographic location, wherein the list of nodes is based at least in part on the network accessible menu.

9. A system comprising:
one or more sensors to capture data related to a food item;
a location module to determine the vendor of the food item;
a food item identification module to
generate a list of nodes to identify the food item, wherein one or more nodes of the list of nodes represents a food item available at the vendor and the list is based at least in part on the data and the vendor of the food item, and
sort the list of nodes for a user of the system, wherein the sorting is based at least in part on a probability of one or more nodes corresponding to the food item to be identified; and
a display to display the sorted list of nodes.

10. The system of claim 9, further comprising a time module to determine when the data capture occurred, the list of nodes based at least in part on the time when the data capture occurred.

11. The system of claim 9, wherein one of the sensors comprises an optical lens, the captured data comprises image data, and the image data includes an image of the food item.

12. The system of claim 9, wherein one of the sensors is a microphone, and the captured data comprises an audible description of the food item.

13. The system of claim 9, wherein the food item identification module further to retrieve user information via a network interface included on the device, wherein the list is sorted further based at least in part on the retrieved user information.

14. The system of claim 13, wherein the retrieved user information comprises food item identification history of the user.

15. The system of claim 9, wherein the location module further includes a Global Positioning System (GPS) and wherein the food item identification module is to determine the vendor of the food item by determining the global position of the one or more sensors when the data was captured.

16. The system of claim 9, further comprising
a network interface operatively coupled to the food item identification module, the food item identification module to retrieve a network accessible menu of food items available from the vendor via the network interface, wherein the list of nodes is based at least in part on the network accessible menu.

17. An article of manufacture comprising a computer-readable storage medium having instructions stored thereon to cause a processor to perform operations including:
receiving data related to a food item, the data captured via one or more sensors included in a device;
determining the location of the device when the data was captured;
generating a list of nodes to identify the food item, wherein one or more nodes of the list of nodes represents a food item available at the location, the list based at least in part on the data and the location of the device when the data was captured; and
sorting the list of nodes for a user of the device, wherein the sorting is based at least in part on a probability of one or more nodes corresponding to the food item to be identified.

18. The article of manufacture of claim 17, further comprising determining the time when the data capture occurred, wherein the list is based at least in part on the time when the data capture occurred.

19. The article of manufacture of claim 17, wherein the one or more sensors included in the device comprises at least one of
an optical lens, wherein the captured data comprises image data and the image data includes an image of the food item; and
a microphone, wherein the captured data comprises an audible description of the food item.

20. The article of manufacture of claim 17, wherein generating a list of nodes includes:
retrieving user information via a network interface included on the device, wherein the list is sorted further based at least in part on the retrieved user information.

21. The article of manufacture of claim 17, wherein generating a list of nodes includes:
retrieving user information stored on the device, wherein the list is sorted based at least in part on the retrieved user information.

22. The article of manufacture of claim 17, wherein the device further includes a Global Positioning System (GPS) and determining the location of the food item comprises determining the global position of the device when the data was captured.

23. The article of manufacture of claim 17, further comprising retrieving, via a network interface included in the device, a network accessible menu of food items for the location, wherein the list of nodes is based at least in part on the network accessible menu.
